(19) United States
(12) Patent Application Publication
(10) Pub. No.: US 2012/0216418 A1
(43) Pub. Date: Aug. 30, 2012

(54) CONFIGURATION AND METHOD FOR THE MAINTENANCE OF HEARING DEVICES

(75) Inventors: MAJA SERMAN, ERLANGEN-BUCKENHOF (DE); MEIKE STEINBUSS, ERLANGEN (DE)

(73) Assignee: SIEMENS MEDICAL INSTRUMENTS PTE. LTD., SINGAPORE (SG)

(21) Appl. No.: 13/404,183

(22) Filed: Feb. 24, 2012

(30) Foreign Application Priority Data
Feb. 24, 2011 (DE) 10 2011 004 679.8

(51) Int. Cl. F26B 21/08; F26B 3/00; F26B 21/06

(52) U.S. Cl. 34/282; 34/549; 34/543

(57) ABSTRACT

A configuration and an associated method dry a hearing device. The configuration includes a heating unit for generating warm air, at least one hearing device, a first humidity sensor of the hearing device for determining first ambient humidity measured values, a signal output unit of the hearing device for outputting the first ambient humidity measured values, a signal recording unit for recording the first ambient humidity measured values, and a control unit for controlling the heating unit in dependence on the first ambient humidity measured values. Accordingly the drying process can be controlled precisely by the heating device in respect of duration and temperature.

### CROSS-REFERENCE TO RELATED APPLICATION

This application claims the priority, under 35 U.S.C. §119, of German application DE 10 2011 004 679.8, filed Feb. 24, 2011; the prior application is herewith incorporated by reference in its entirety.

### BACKGROUND OF THE INVENTION

### Field of the Invention

The invention relates to a configuration and a method for maintenance by drying and desalinating hearing devices.

Hearing devices are wearable hearing apparatuses which are used to supply the hard-of-hearing. To accommodate the numerous individual requirements, different configurations of hearing devices such as behind-the-ear hearing devices, hearing device with an external receiver and in-the-ear hearing devices, e.g. also concha hearing devices or canal hearing devices are provided. The hearing devices given by way of example are worn on the outer ear or in the auditory canal. Furthermore, bone conduction hearing aids, implantable or vibrotactile hearing aids are also available on the market. In such cases the damaged hearing is stimulated either mechanically or electrically.

Essential components of the hearing devices include in principal an input converter, an amplifier and an output converter. The input converter is generally a recording transducer, e.g. a microphone and/or an electromagnetic receiver, e.g. an induction coil. The output converter is mostly realized as an electroacoustic converter, e.g. a miniature loudspeaker, or as an electromechanical converter, e.g. a bone conduction receiver. The amplifier is usually integrated into a signal processing unit. This basic structure is shown in the example in FIG. 1 of a behind-the-ear hearing device 1. Two microphones 3 for recording the ambient sound are usually incorporated in a hearing device housing 2 to be worn behind the ear. Microphone openings 7 are embodied in the hearing device housing 2 above the microphones 3. The sound can reach the microphones 3 inside the hearing device housing through the sound openings 7. A signal processing unit 3, which is similarly integrated into the hearing device housing 2, processes the microphone signals and amplifies them. The output signal of the signal processing unit 4 is transmitted to a loudspeaker and/or receiver 5, which outputs an acoustic signal. The sound is optionally transmitted to the ear drum of the device wearer via a non-illustrated sound tube, which is fixed with an otoplastic in the auditory canal. The power supply of the hearing device 1 and in particular of the signal processing unit 4 is supplied by a battery 6 which is likewise integrated into the hearing device housing 2.

Hearing devices are worn on the head. They are therefore also constantly exposed to the perspiration of the wearer. This results in increased humidity collecting on the hearing device and in particular also on the electronic components of the hearing device. One consequence may be that the electronics and thus the overall device fail. It is therefore necessary for the hearing device to be dried at regular intervals. Practically, the hearing device is placed in a drying facility after wear, for instance at night, before the hearing device wearer goes to bed.

Two methods are currently conventional in terms of drying and/or dehumidifying a hearing device after usage. According to a first method, the hearing device is placed in a storage container, in which a silica gel package is found. According to a second method, the hearing device is plugged into a battery charging device for dehumidification, the battery charging device having a heating element.

U.S. patent publication No. 2005/0122708 A1 describes a dehumidifier, in which a lamp heats the air. The heated air is routed into a container through perforations, into which container a hearing device can be placed.

Published, European patent application EP 1 411 749 A2 discloses a dehumidifier which contains a sensor. The sensor controls the quantity of heat generated in order to keep the inner temperature in the hearing device drying container sufficiently high.

Humidity sensors are known for detecting humidity. For instance, published European patent application EP 2 136 975 A1 specifies a cochlea implant, which includes a humidity sensor for generating a signal. The signal indicates humidity within the implant.

### SUMMARY OF THE INVENTION

It is accordingly an object of the invention to provide a configuration and a method for the maintenance of hearing devices which overcome the above-mentioned disadvantages of the prior art devices and methods of this general type, which optimize the drying of a hearing device.

The invention claims a configuration for drying a hearing device. The configuration includes a heating unit for generating warm air and at least one hearing device. Furthermore, the configuration includes a first humidity sensor of the hearing device which determines first ambient humidity measured values, a signal output unit of the hearing device which outputs the first ambient humidity measured values, a signal recording unit which records the first ambient humidity measured values, and a control unit which controls the heating unit in dependence on the first ambient humidity measured values. The invention is advantageous in that the drying process can be precisely controlled by the hearing device in respect of duration and temperature.

In a development of the invention, the first humidity sensor is arranged inside a hearing device housing and the first ambient humidity measured values are determined inside the hearing device. As a result, the drying process can be controlled by the moisture inside the hearing device.

In a further embodiment, the configuration includes a second humidity sensor which is arranged outside on the hearing device housing or is integrated into the hearing device housing, the second humidity sensor determining the second ambient humidity measured values outside of the hearing device housing.

Furthermore, the signal output unit can output the second ambient humidity measured values, the signal recording unit can record the second ambient humidity measured values and the control unit can control the heating unit in dependence on the second ambient humidity measured values.

In a development, the control unit can determine a remaining drying period on the basis of the first and/or second ambient humidity measured values and/or change the heating output of the heating unit. The drying process is optimized as a result.

In a further embodiment, the configuration includes a storage container, in which the heating unit, the signal recording unit and the control unit are arranged and the hearing device is stored for drying purposes.

The storage container may preferably contain a display unit, which indicates the remaining drying period.

The storage container can preferably contain a transmission unit, which transmits the remaining drying period to an external unit.

The external unit may also be a hearing device remote control or a Smartphone.

In a development, the configuration may include a desalination unit, which outputs a desalination agent to the air, whereby a salinity measuring sensor of the hearing device determines the salinity measured values outside the hearing device housing, the signal output unit of the hearing device outputs the salinity measured values, the signal recording unit records the salinity measured values and the control unit controls the desalination unit as a function of the salinity measured values. The advantage here is that a desalination process can be controlled precisely.

In a further embodiment, the storage container includes a control unit, with which the function of the desalination unit and/or the heating unit can be controlled.

The storage container preferably includes a battery charging unit, which charges rechargeable batteries in the hearing device during the drying or desalination process.

The invention also claims a method for drying a hearing device with a heating unit. The method includes: determining first ambient humidity measured values by the hearing device, outputting the determined first ambient humidity measured values by the hearing device, and controlling the heating unit in dependence on the output first ambient humidity measured values.

In a development, the first ambient humidity measured values are determined within a hearing device housing of the hearing device.

In a further embodiment, the method includes the following additional steps of: determining two ambient humidity measured values outside the hearing device housing, outputting the determined second ambient humidity measured values by the hearing device, and controlling the heating unit in dependence on the output second ambient humidity measured values.

On the basis of the first and/or second ambient humidity measured values, a remaining drying period is preferably determined and/or the heating output of the heating unit is changed.

Furthermore, the remaining drying period can be displayed on a storage container and/or an external unit.

Furthermore, the method can include the following additional steps of: determining salinity measured values by the hearing device, outputting the determined salinity measured values by the hearing device, and controlling a desalination unit, which outputs a desalination agent to the air, as a function of the output salinity measured values.

Other features which are considered as characteristic for the invention are set forth in the appended claims.

Although the invention is illustrated and described herein as embodied in a configuration and a method for the maintenance of hearing devices, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration showing a hearing device according to the prior art;

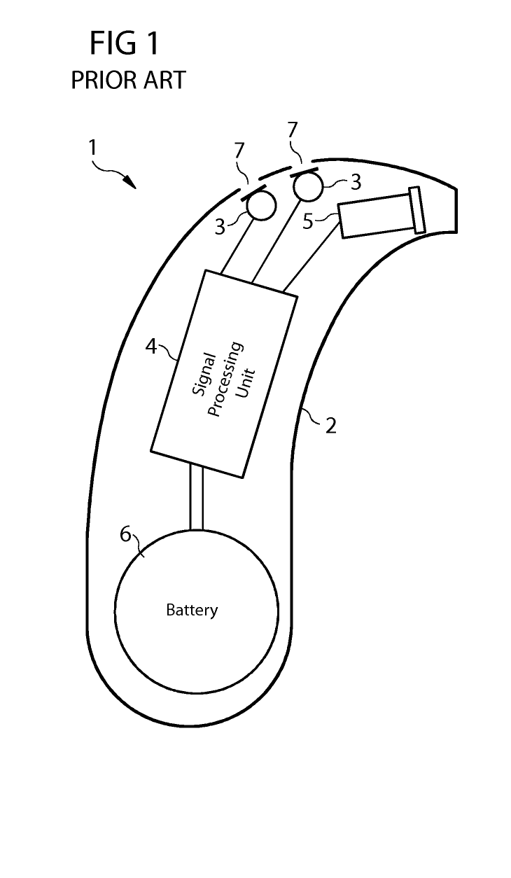

FIG. 2 is an illustration showing a configuration with a hearing device, a heating unit and a desalination unit according to the invention;

FIG. 3 is a diagrammatic, perspective view of a storage container with a hearing device according to the invention; and

FIG. 4 is a flow diagram for describing a method for drying and desalinating a hearing device according to the invention.

### DETAILED DESCRIPTION OF THE INVENTION

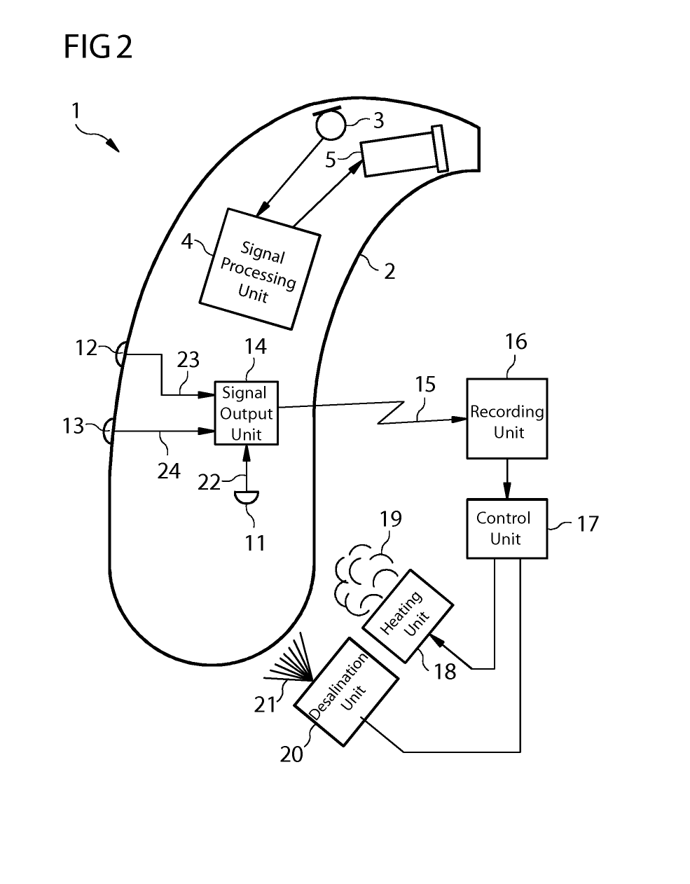

Referring now to the figures of the drawing in detail and first, particularly, to FIG. 2 thereof, there is shown a configuration for drying and desalinating a hearing device. A behind-the-ear hearing device 1 is shown with a hearing device housing 2. A microphone 3, a receiver 5 and a signal processing unit 4 are found in the hearing device housing 2. Furthermore, a first humidity sensor 11 is arranged in accordance with the invention inside of the hearing device housing 2, the humidity sensor 11 measuring a first ambient humidity within the hearing device housing and determining first ambient humidity measured values 22. A second humidity sensor 12 is attached to the exterior of the hearing device housing 2, the second humidity sensor 12 measuring a second ambient humidity outside the hearing device and determining second ambient humidity measured values 23.

The determined first and second ambient humidity measured values 22, 23 are transmitted to a signal output unit 14 of the hearing device 1 and are output from there by radio signal 15 to a signal recording unit 16 outside the hearing device 1. The radio signal 15 is part of an inductive data transmission for instance. The signal recording unit 16 transmits the first and second ambient humidity measured values 22, 23 to a control unit 17, which controls a heating unit 18 and a desalination unit 20. As a function of the first and second ambient humidity measured values 22, 23, the heating unit 18 outputs hot air 19 and/or heats the ambient air. The heating process is terminated once a lower limit value is achieved by the first and second ambient humidity measured values 22, 23. The hearing device is dried.

At the same time, a saline layer caused by perspiration on the hearing device housing 2 can also be removed for instance. To this end, a salinity measuring sensor 13 measures the salt concentration outside the hearing device housing 2 and forwards this information as salinity measured values 24 to the signal output unit 14. The salinity measuring sensor 13 rests on the hearing device housing 2 or is integrated therein. The signal output unit 14 transmits the salinity measured values 24 to the signal recording unit 16 by radio signal 15, the signal recording unit 16 forwarding the salinity measured values 24 to the control unit 17. The control unit 17 is connected to a desalination unit 20, which according to the salinity measured values 24 outputs and/or sprays more or less desalination agent 21 to the air. The desalination agent 21 is deposited on the surface of the hearing device housing 2 and dissolves the bothersome salt. It is then briefly dried with the heating unit 18.

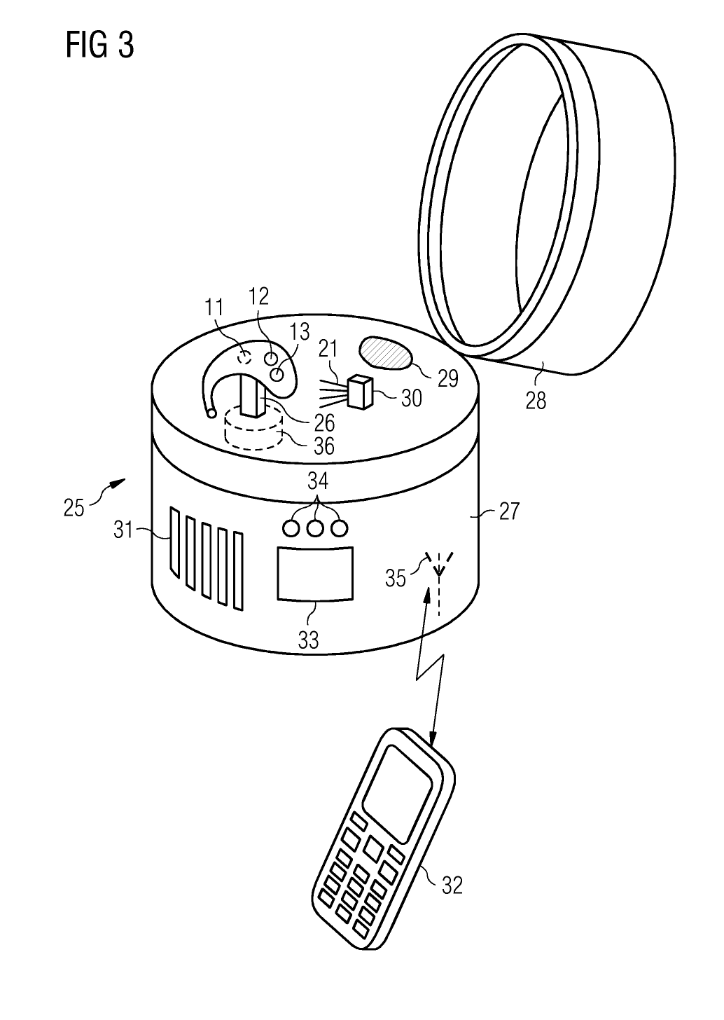

FIG. 3 shows a spatial view of a storage container 25 with a lower part 27 and a cover 28 for closing the lower part 27. The hearing device 1 is fastened to a support 26 in the lower part 27 and in anticipation of undergoing the drying and desalination process. With a closed cover 28, air enters the interior of the storage container 25 through an air inlet 31 in the lower part 27, the air being heated by a heating unit in the lower part 27 (not shown) and flowing through an outlet 29 in the lower part 27 into the cavity formed by the closed cover 28 and the lower part 27 and drying the hearing device 1. A desalination agent 21 reaches the cavity and thus the hearing device 1 by a spray head 30. The desalination agent 21 is sprayed by a desalination unit which is not visible. The first and second humidity sensor 11, 12 of the hearing device 1 controls the drying process in accordance with the invention. The salinity measuring sensor 13 controls the desalination process in accordance with the invention.

The remaining drying and/or desalination period can be indicated on a display 33 in the lower part 27 and/or on a remote control 32. The drying and/or desalination process can be switched on/off and controlled by the hearing device user by way of the remote control 32 or with the aid of a control unit 34 of the storage container 25. In this process the necessary data is exchanged between the remote control 32 or alternatively a smartphone and the storage container 25 with the aid of a transmission unit 35.

A rechargeable battery of the hearing device can be charged during the drying or desalination process by way of a battery charging unit 36 in the lower part 27.

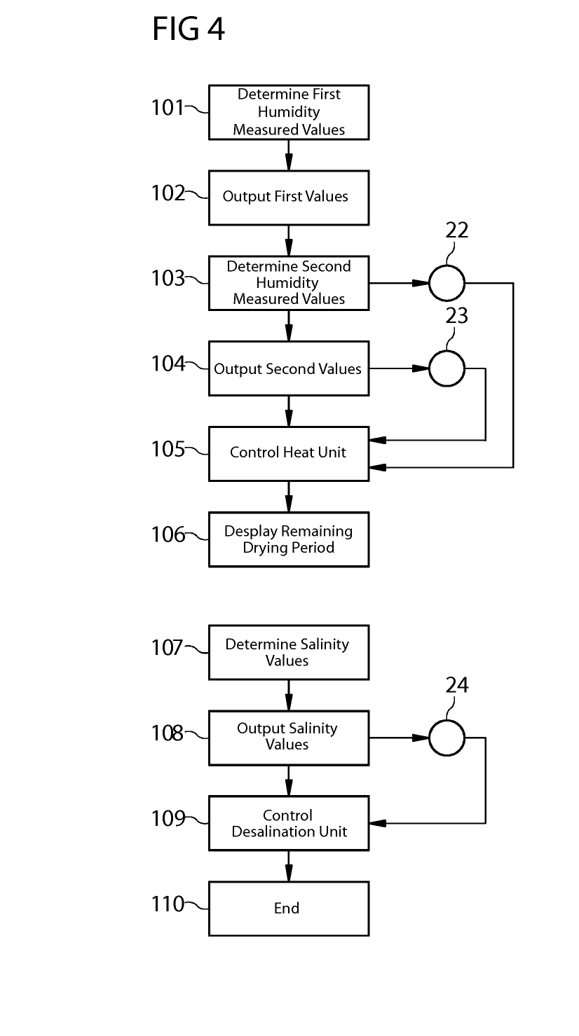

FIG. 4 shows a flow diagram of an inventive method for drying and desalinating a hearing device. In step 101, first ambient humidity measured values 22 are determined within a hearing device housing of the hearing device by the hearing device. In step 102, the determined first ambient humidity measured values 22 are output by the hearing device. In step 103, second ambient humidity measured values 23 are determined outside the hearing device housing by the hearing device. In step 104, the determined second ambient humidity measured values 23 are output by the hearing device. In step 105, a heating unit is controlled in dependence on the output first and second ambient humidity measured values 22, 23. For instance, a remaining drying period is determined on the basis of the first and/or second ambient humidity measured values 22, 23 and/or the heating output of the heating unit is changed for instance. In step 106, the remaining drying period is displayed on a storage container and/or on an external unit.

In step 107, salinity measured values 24 are determined by the hearing device. In step 108, the determined salinity measured values 24 are output by the hearing device. In step 109, a desalination unit, which outputs a desalination agent to the air, is controlled as a function of the output salinity measured values 24.

1. A configuration for drying a hearing device, comprising:
a heating unit for generating warm air;
a first humidity sensor supported by the hearing device for determining first ambient humidity measured values;
a signal output unit housed in the hearing device for outputting the first ambient humidity measured values;
a signal recording unit for recording the first ambient humidity measured values; and
a control unit controlling said heating unit in dependence on the first ambient humidity measured values.

2. The configuration according to claim 1, wherein said first humidity sensor is disposed inside a hearing device housing and determines the first ambient humidity measured values inside the hearing device.

3. The configuration according to claim 2, further comprising a second humidity sensor disposed outside on the hearing device housing or integrated in the hearing device housing, said second humidity sensor determining second ambient humidity measured values outside the hearing device housing.

4. The configuration according to claim 3, wherein said signal output unit outputs the second ambient humidity measured values, said signal recording unit records the second ambient humidity measured values and said control unit controls said heating unit in dependence on the second ambient humidity measured values.

5. The configuration according to claim 4, wherein said control unit determines a remaining drying period on a basis of at least one of the first or second ambient humidity measured values or changes a heating output of said heating unit.

6. The configuration according to claim 1, further comprising a storage container, in which said heating unit, said signal recording unit and said control unit are disposed and the hearing device is stored for drying purposes.

7. The configuration according to claim 6, wherein said storage container has a display unit for displaying a remaining drying period.

8. The configuration according to claim 5, further comprising:
an external unit; and
a transmission unit for transmitting a remaining drying period to said external unit.

9. The configuration according to claim 8, wherein said external unit is a hearing device remote control or a smartphone.

10. The configuration according to claim 1,
further comprising a desalination unit outputting a desalination agent to the air;
further comprising a salinity measuring sensor for the hearing device for determining salinity measured values outside the hearing device housing;
wherein said signal output unit of the hearing device outputs the salinity measured values;
wherein said signal recording unit records the salinity measured values; and
wherein said control unit controls said desalination unit in dependence on the salinity measured values.

11. The configuration according to claim 10, further comprising a further control unit, disposed on said storage container, with which a functioning of at least one of said desalination unit or said heating unit can be controlled.

12. The configuration according to claim 6, wherein said storage container has a battery charging unit for charging rechargeable batteries of the hearing device during a drying process.

13. A method for drying a hearing device with a heating unit, which comprises the steps of:
determining first ambient humidity measured values by means of the hearing device;
outputting the first ambient humidity measured values determined by means of the hearing device; and
controlling the heating unit in dependence on the first ambient humidity measured values output.

14. The method according to claim 13, which further comprises determining the first ambient humidity measured values within a hearing device housing of the hearing device.

15. The method according to claim 13, which further comprises:
determining second ambient humidity measured values outside of the hearing device housing;
outputting the second ambient humidity measured values determined by means of the hearing device; and
controlling the heating unit in dependence on the second ambient humidity measured values.

16. The method according to claim 15, which further comprises:
determining a remaining drying period on a basis of at least one of the first ambient humidity measured values or the second ambient humidity measured values; and
changing a heating output of the heating unit.

17. The method according to claim 16, which further comprises displaying the remaining drying period on at least one of a storage container or an external unit.

18. The method according to claim 13, which further comprises:
determining salinity measured values by means of the hearing device;
outputting the salinity measured values determined by means of the hearing device; and
controlling a desalination unit, which outputs a desalination agent to the air, in dependence on the salinity measured values.

19. The method according to claim 18, which further comprises drying the hearing device.
